(19) United States
(12) Patent Application Publication
(10) Pub. No.: US 2017/0300311 A1
(43) Pub. Date: Oct. 19, 2017

(54) Dynamic Image Generation

(71) Applicant: Microsoft Technology Licensing, LLC, Redmond, WA (US)

(72) Inventors: Daniel Vasquez Lopez, Duvall, WA (US); Morakinyo Olugbade, Seattle, WA (US); Frederick J. Smith, Redmond, WA (US); Benjamin M. Schultz, Bellevue, WA (US); Hari R. Pulapaka, Redmond, WA (US); Mehmet Iyigun, Kirkland, WA (US)

(73) Assignee: Microsoft Technology Licensing, LLC, Redmond, WA (US)

(21) Appl. No.: 15/130,512

(22) Filed: Apr. 15, 2016

(51) Int. Cl. G06F 9/445

(52) U.S. Cl. CPC G06F 8/63

(57) ABSTRACT

Techniques described herein can dynamically generate images. In one example, a method includes detecting a request to generate a container image based on a policy file and identifying a host image from a host operating system. The method can also include generating the container image based on the host image and the policy file, the policy file indicating a first set of files to be copied from the host image to the container image, a set of reparse points corresponding to a second set of files not to be copied from the host image to the container image, and a third set of files to be loaded into the container image from a remote source.

### BACKGROUND

The use of virtualized servers has enabled a rapid growth in sharing processing resources and data for on-demand software services. For example, virtualized servers can be used to process data from users and enterprises in third party data centers. In some examples, the virtualized servers can be executed by a kernel of a host operating system that enables multiple isolated instances of software containers (also referred to herein as containers). The software containers can include any suitable operating system and any number of applications. Accordingly, a host server can implement any suitable number of software containers that include isolated user-space instances of virtualized servers with an operating system and corresponding applications.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for generating images comprising a processor that can detect a request to generate a container image based on a policy file and identify a host image from a host operating system. The processor can also generate the container image based on the host image and the policy file, the policy file indicating a first set of files to be copied from the host image to the container image and a set of reparse points to be created in the container image, the set of reparse points corresponding to a second set of files not to be copied from the host image to the container image.

In another embodiment, a method for generating images can include detecting a request to generate a container image based on a policy file and identifying a host image from a host operating system. The method can also include generating the container image based on the host image and the policy file, the policy file indicating a first set of files to be copied from the host image to the container image, a set of reparse points to be created in the container image, the set of reparse points corresponding to a second set of files not to be copied from the host image to the container image, and a third set of files to be loaded into the container image from a remote source.

In yet another embodiment, one or more computer-readable storage devices for dynamically generating images can include a plurality of instructions that, based at least on execution by a processor, cause the processor to detect a request to generate a container image based on a policy file. The plurality of instructions can also cause the processor to identify a host image from a host operating system and generate the container image based on the host image and the policy file, the policy file indicating a first set of files to be copied from the host image to the container image, a set of reparse points to be created in the container image, the set of reparse points corresponding to a second set of files not to be copied from the host image to the container image, and a third set of files to be loaded into the container image from a remote source. Additionally, the plurality of instructions can cause the processor to store the container image in a container image store.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can generate a container image;

FIG. 2 is a block diagram illustrating an image generator that can generate a container image;

FIG. 3 is a process flow diagram illustrating a method for generating a container image;

FIG. 4 is a process flow diagram illustrating a method for dynamically generating a container image;

FIG. 5 is a block diagram of an example host image and container image; and

FIG. 6 is a block diagram of an example computer-readable storage media that can dynamically generate a container image.

### DETAILED DESCRIPTION

Operating systems have used disk images to assist in deployment for years. Disk images of an operating system and pre-installed applications save installation time and unify configuration efforts. Instead of installing individual instances of an operating system and performing piecemeal application installation, a user can download the image and boot to the image. The deployment model for virtual machine-based virtualization works much the same way as described above, dependent on disk images. Moreover, container-based virtualization has offered higher compatibility between applications and virtualized servers, as well as an increased density, enabling more virtualized servers to simultaneously run on each host server. Therefore, container-based virtualization can lower costs of software development and increase revenue for the same facilities and hardware.

However, container-based virtualization can create an issue in which a container image is independent of a host image. This problem may exist both with server operating systems that run in data center environments and in client operating systems that run on consumer computers and devices. In some examples, independent images can create deployment and distribution inefficiencies. For example, each new container can result in downloading and deploying a new image, which can be computationally expensive in terms of download time, network bandwidth and storage I/O. Furthermore, independent host images and container images can result in duplicate files that consume large amounts of memory. Moreover, configuration changes for host images and container images can result in individually updating each image.

Sharing an image between a host and a container also creates several issues. For example, sensitive data stored on the host can be shared with a container. Also, files that are opened by a container are locked and cannot be opened by the host. Furthermore, new files, such as registry and configuration files, created by the container may be unexpected by the host and vice versa.

The techniques describe herein dynamically create container images and utilize a layered image runtime environment. This enables both the desired efficiencies of sharing files between a base or host environment and a container while executing guest instances of containers in isolated environments. In embodiments described herein, a system can detect a request to generate a container image based on a policy file. A container image, as described herein, can include any suitable number of operating system files, applications, log files, temporary files, and the like. A policy file, as described herein, can indicate when to generate a container image, security levels corresponding to files in the container image, reparse points to include in the container image, copies of files from a host image to be included in a container image, and files or applications to be included in the container image from a remote source. In some embodiments, the system can identify the host image from a host operating system. In some embodiments, the system can also generate the container image based on the host image and the policy file. As discussed above, the policy file can indicate a first set of files to be copied from the host image to the container image, a set of reparse points corresponding to a second set of files not to be copied from the host image to the container image, and a third set of files to be loaded into the container image from a remote source. A reparse point, as referred to herein, can include any suitable file system pointer. The container images can be generated dynamically and can be nested or layered according to techniques described below.

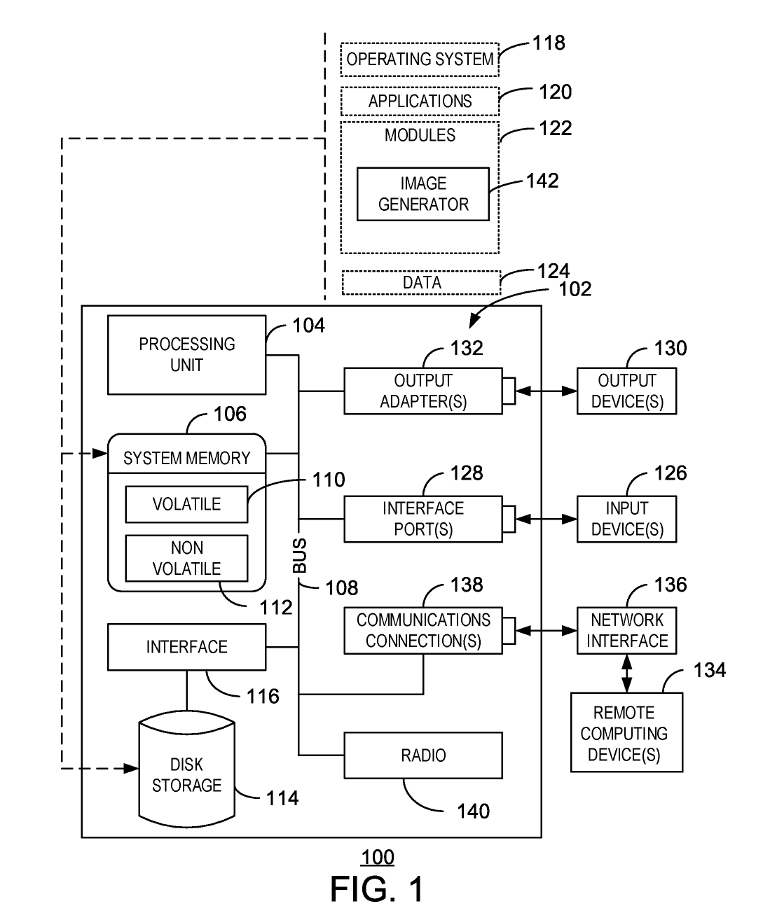

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 discussed below, provide details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that can generate a container image. The example system 100 includes a computing device 102. The computing device 102 includes a processing unit 104, a system memory 106, and a system bus 108. In some examples, the computing device 102 can be a gaming console, a personal computer (PC), a phone, an accessory console, a gaming controller, among other computing devices. In some examples, the computing device 102 can be a node in a cloud network.

The system bus 108 couples system components including, but not limited to, the system memory 106 to the processor or processing unit 104. The processing unit 104 can be any of various available processors. Dual microprocessors and other multiprocessor architectures also can be employed as the processing unit 104.

The system bus 108 can be any of several types of bus structure, including the memory bus or memory controller, a peripheral bus or external bus, and a local bus using any variety of available bus architectures known to those of ordinary skill in the art. The system memory 106 includes computer-readable storage media that includes volatile memory 110 and nonvolatile memory 112.

Volatile memory 110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The basic input/output system (BIOS), containing the basic routines to transfer information between elements within the computer 102, such as during start-up, is stored in nonvolatile memory 112. By way of illustration, and not limitation, nonvolatile memory 112 can include read-only memory (ROM), programmable ROM (PROM), electrically programmable ROM (EPROM), electrically erasable programmable ROM (EEPROM), or flash memory. Some nonvolatile memory 112 such as ReRAM (e.g. 3D Xpoint) may be used in the same manner as volatile cache memory.

The computer 102 also includes other computer-readable media, such as removable/non-removable, volatile/non-volatile computer storage media. FIG. 1 shows, for example a disk storage 114. Disk storage 114 includes, but is not limited to, devices like a magnetic disk drive, floppy disk drive, tape drive, Jaz drive, Zip drive, LS-210 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer 102.

System applications 120 take advantage of the management of resources by operating system 118 through program modules 122 and program data 124 stored either in system memory 106 or on disk storage 114. It is to be appreciated that the disclosed subject matter can be implemented with various operating systems or combinations of operating systems.

A user enters commands or information into the computer 102 through input devices 126. Input devices 126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 126 connect to the processing unit 104 through the system bus 108 via interface ports 128. Interface ports 128 include, for example, a serial port, a parallel port, a game port, and a universal serial bus (USB).

Output devices 130 use some of the same type of ports as input devices 126. Thus, for example, a USB port may be used to provide input to the computer 102 and to output information from computer 102 to an output device 130.

Output adapter 132 is provided to illustrate that there are some output devices 130 like monitors, speakers, and printers, among other output devices 130, which are accessible via adapters. The output adapters 132 include, by way of illustration and not limitation, video and sound cards that provide a means of connection between the output device 130 and the system bus 108. It can be noted that other devices and systems of devices provide both input and output capabilities such as remote computing devices 134.

The computer 102 can be a server hosting various software applications in a networked environment using logical connections to one or more remote computers, such as remote computing devices 134. The remote computing devices 134 may be client systems configured with web browsers, PC applications, mobile phone applications, and the like. The remote computing devices 134 can be a personal computer, a server, a router, a network PC, a workstation, a microprocessor based appliance, a mobile phone, a peer device or other common network node and the like, and typically includes many or all of the elements described relative to the computer 102.

Remote computing devices 134 can be logically connected to the computer 102 through a network interface 136 and then connected via a communication connection 138, which may be wireless. Network interface 136 encompasses wireless communication networks such as local-area networks (LAN) and wide-area networks (WAN). LAN technologies include Wireless LAN (such as specified by IEEE 802.11), Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 138 refers to the hardware/software employed to connect the network interface 136 to the bus 108. While communication connection 138 is shown for illustrative clarity inside computer 102, it can also be external to the computer 102. The hardware/software for connection to the network interface 136 may include, for exemplary purposes, internal and external technologies such as, mobile phone switches, modems including regular telephone grade modems, cable modems and DSL modems, ISDN adapters, and Ethernet cards.

The computer 102 can further include a radio 140. For example, the radio 140 can be a wireless local area network radio that may operate one or more wireless bands. For example, the radio 140 can operate on the industrial, scientific, and medical (ISM) radio band at 2.4 GHz or 5 GHz. In some examples, the radio 140 can operate on any suitable radio band at any radio frequency.

The computer 102 includes one or more modules 122, such as an image generator 142, configured to enable dynamically generating a container image. In some embodiments, the image generator 142 can detect a request to generate a container image based on a policy file and identify a host image from a host operating system. The image generator 142 can also generate the container image based on the host image and the policy file, the policy file indicating a first set of files to be copied from the host image to the container image and a set of reparse points to be created in the container image. In some examples, the set of reparse points correspond to a second set of files not to be copied from the host image to the container image. The policy file can also indicate a third set of files to be loaded into the container image from a remote source. For example, the policy file can indicate that an application or file is to be retrieved from an external memory drive, a remote computing device, and the like.

It is to be understood that the block diagram of FIG. 1 is not intended to indicate that the computing system 102 is to include all of the components shown in FIG. 1. Rather, the computing system 102 can include fewer or additional components not illustrated in FIG. 1 (e.g., additional applications, additional modules, additional memory devices, additional network interfaces, etc.). Furthermore, any of the functionalities of the image generator 142 may be partially, or entirely, implemented in hardware and/or in the processor 104. For example, the functionality may be implemented with an application specific integrated circuit, in logic implemented in the processor 104, or in any other device.

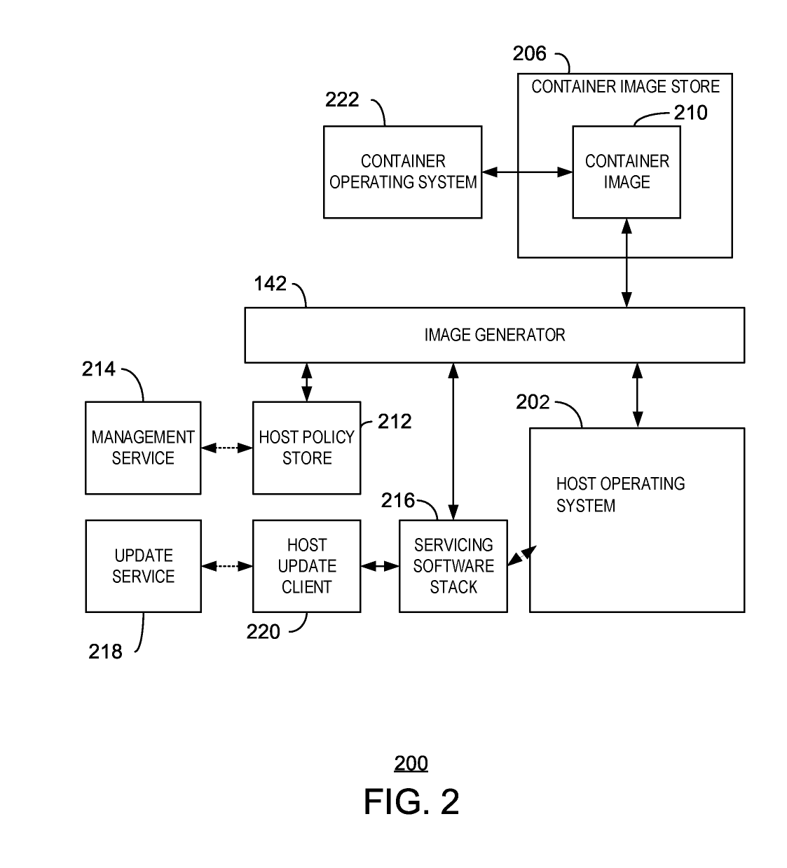

FIG. 2 is a block diagram illustrating an image generator that can generate a container image. The image generator can be implemented by any suitable computing device, such as the computing system 102 of FIG. 1.

In some embodiments, the image generator 142 can transmit data to a host operating system 202 and a container image store 206. In some embodiments, the host operating system 202 can be referred to as a host operating system and a subset of files in the host operating system 202 can be identified as a host image. A host image, as referred to herein, includes a set of reference files that are executed by the host operating system 202. The reference files can include executable files that provide functionality for the operating system kernel and drivers, the security subsystem, configuration files, files that describe user information, and files that represent software applications, among others. The container image store 206 can store or include container images, such as container image 210, that can include files and applications that do not exist in the host operating system 202 and a set of pointers to references in the host operating system 202. The files and applications in the container image 210 that do not exist in the host operating system 202 can include new files in the container image 210, files that have been replaced in the container image 210, and files that have no link to the host operating system 202.

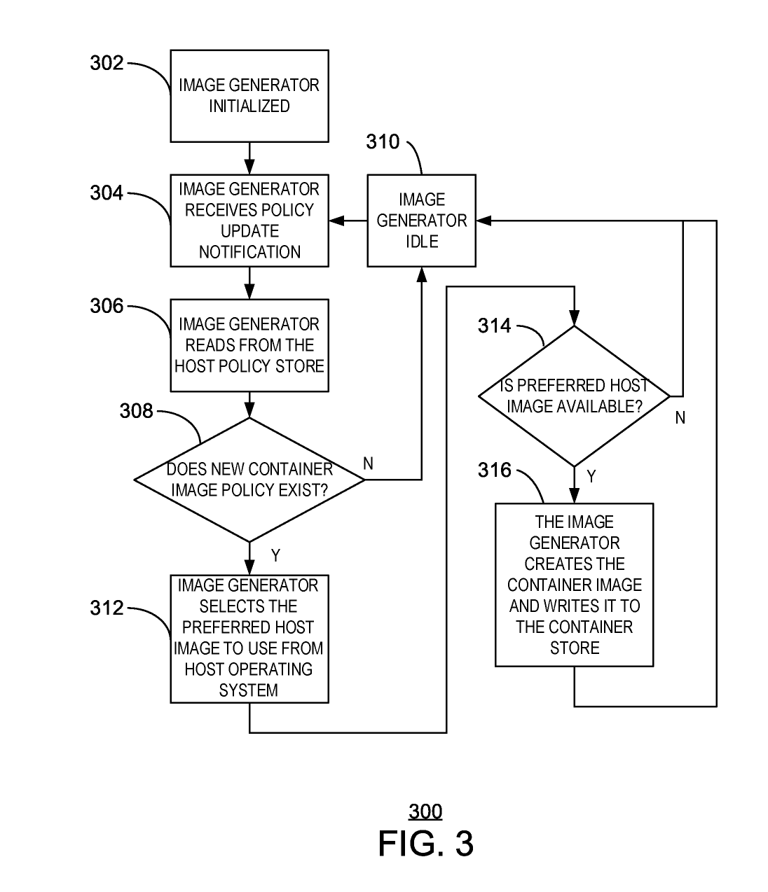

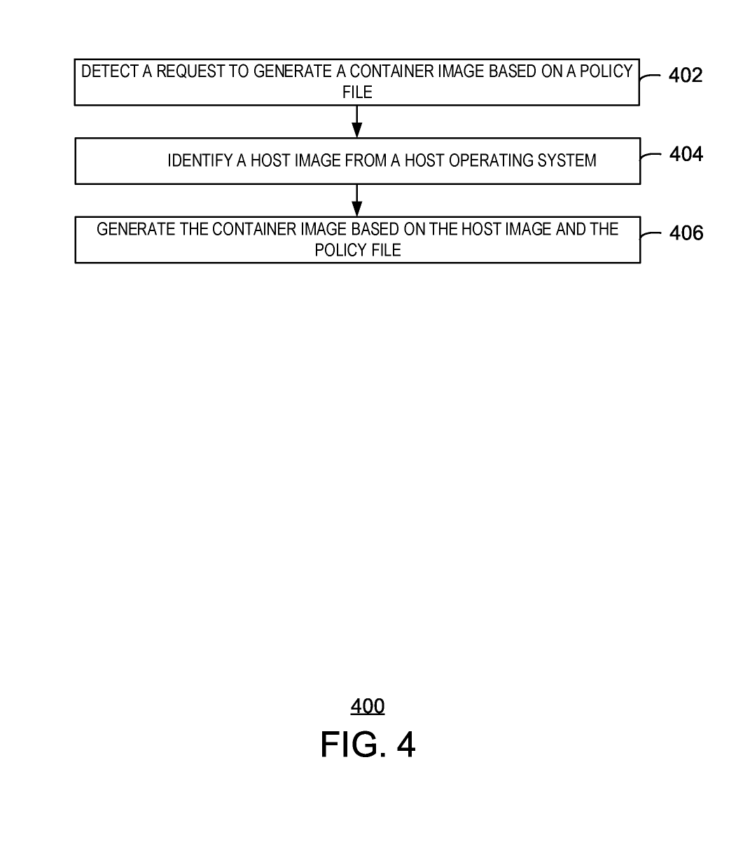

In some embodiments, the image generator 142 can generate the container image 210 in the container image store 206 based on a policy from a host policy store 212. The policy can indicate when to generate a container image, security levels corresponding to files in the container image, reparse points to include in the container image, copies of files from a host image to be included in a container image, and files or applications to be included in the container image from a remote source, among others. The policies stored in the host policy store 212 can be generated and transmitted to the policy store 212 by a management service 214. In some embodiments, the host policy store 212 can store a policy in a policy file that indicates a location of an application or file to be included in the container image 210 from an external source. For example, the policy can indicate that the management service 214 includes an application that is to be transmitted to the container image 210. In some examples, the host policy store 212 can indicate that the application or file from the external source is to be transmitted to the host operating system 202 and the container image 210. Policies are described in greater detail below in relation to FIGS. 3 and 4.

In some embodiments, the host operating system 202 can also communicate with a servicing software stack 216, which can indicate to the host operating system 202 and the image generator 142 when files are to be modified or updated. For example, the servicing software stack 216 can indicate that a driver file is to be updated, a new driver file is to be installed, a kernel file is to be modified, and the like. In some embodiments, the servicing software stack 216 receives the updated files or instructions to update files from an update service 218 via a host update client 220 in the host operating system 202. In response to the modification of files, the image generator 142 can determine a time to delete a container image 210 and generate a new replacement container image with the modified files or reparse points corresponding to the modified files. In some embodiments, the container image 210 can include a container operating system 222.

It is to be understood that the block diagram of FIG. 2 is not intended to indicate that the operating system 200 is to include all of the components shown in FIG. 2. Rather, the operating system 200 can include fewer or additional components not illustrated in FIG. 2.

FIG. 3 is a process flow diagram illustrating a method for generating a container image. The method 300 can be implemented with any suitable computing device, such as the computing system 102 of FIG. 1.

At block 302, a system can initialize an image generator. For example, the image generated can be initialized each time a host operating system is loaded in a computing device. At block 304, the image generator can detect a policy update notification. In some examples, the image generator can receive the update notification from a host update client or servicing stack. The policy update notification can indicate that an existing policy has been modified, which can result in the generation of new container images.

At block 306, the image generator can read from a host policy store. The host policy store can include any suitable number of policies that indicate when and how to generate a container image. For example, a policy file can indicate that a new instance of a log file is to be initialized in a container image. The policy file can also indicate an access control list corresponding to files stored in the container image, files accessed from the host image by the container image using reparse points, and files loaded into the container image from a remote source. In some embodiments, the policy file can indicate the container image is to be deleted and a second container image is to be generated in response to detecting a modification to the host image. In some examples, the policy file can indicate the container image is to be deleted and a second container image is to be generated in response to detecting a security vulnerability in the container image. For example, a security vulnerability can include any file or application executed in a container image that may attempt to access unauthorized data in the host image. In some embodiments, container images with security vulnerabilities can be scheduled to be deleted periodically and replaced with new instances of the container images.

In some examples, the policy file can also indicate whether a host image is to implement a copy-on-write technique to prevent modifications to the host image from being accessed by the container image. For example, the policy file can indicate if the image generator detects a request to modify a file in the host image, the image generator can generate a copy of the file in the host image, modify a reparse point in the container image to point to the copy of the file, and modify the file. In some embodiments, the copy-on-write technique can also include detecting a file to be deleted from the host image and maintaining a reparse point in the container image corresponding to the file to be deleted. Accordingly, the copy-on-write technique can enable a hard link to exist between the container image and the host image, wherein the hard link provides a reliable and consistent link to a file. In some embodiments, the copy-on-write technique can also include generating a new file in the host image that is inaccessible to the container image.

At block 308, the image generator can determine if a container image policy exists. If the container image policy does not exist, the image generator becomes idle at block 310 before returning back to block 304. If the container image policy exists, the process flow continues at block 312.

At block 312, the image generator selects a preferred host image from a host operating system. In some embodiments, the preferred host image is selected based on a container operating system type, the applications executed in the container, security policies, user settings, such as a level of personally identifiable information that can be accessed by the container, and the like. As discussed above, the preferred host image can include a subset of files from a host operating system.

At block 314, the image generator determines if the preferred host image is available. If the preferred host image is available, the image generator creates a container image and writes the container image to a container image store at block 316. The process then returns to block 310. If the preferred host image is unavailable, the process flow returns to block 310 without creating a container image.

In one embodiment, the process flow diagram of FIG. 3 is intended to indicate that the steps of the method 300 are to be executed in a particular order. Alternatively, in other embodiments, the steps of the method 300 can be executed in any suitable order and any suitable number of the steps of the method 300 can be included. Further, any number of additional steps may be included within the method 300, depending on the specific application.

FIG. 4 is a process flow diagram illustrating a method for dynamically generating a container image. The method 400 can be implemented with any suitable computing device, such as the computing system 102 of FIG. 1.

At block 402, an image generator can detect a request to generate a container image based on a policy file. In some embodiments, the request can originate from a servicing software stack, which indicates that files in a host image are to be modified. The modification to the host image can result in scheduling a container image to be deleted and a new instance of the container to be generated based on the modified files in the host image.

At block 404, an image generator can identify a host image from a host operating system. For example, the image generator can identify a preferred host image that matches a container operating system type, the applications executed in the container, security policies, user settings, such as a level of personally identifiable information that can be accessed by the container, and the like. The preferred host image can include any suitable subset of files from a host operating system.

At block 406, an image generator can generate the container image based on the host image and the policy file. In some embodiments, the policy file can indicate a first set of files to be copied from the host image to the container image and a set of reparse points in the container image corresponding to a second set of files not to be copied from the host image to the container image. The policy file can also indicate a third set of files to be loaded into the container image from a remote source. In some embodiments, the policy file can assign a security level to each of the first set of files. The policy file can be written using any suitable markup language such as the extensible markup language (XML), among others. In some embodiments, if a container image does not exist, the image generator can create a new directory structure for the container image. For each line of the policy file, if the sub-directories and files exist in the source location or host image, the image generator can create a pointer or reparse point back to the host image. If the policy file defines a specific file from the host image that is to be copied to the container image, that specific file can be referenced in the policy file and copied into the container image location.

In some embodiments, the image generator can detect a mismatch between a container image and a policy. For example, a container image may gain access to files that include personally identifiable information. In some examples, the mismatch can occur when a file with sensitive information is added to a directory associated with a reparse point in the container image. In some embodiments, the image generator can periodically consult a security subsystem to assess a security risk. For example, the image generator can determine application types that are executed in the container images and on the host image, a container image's access to user specific data that includes personally identifiable information, and system locations of reference files and directories corresponding to reparse points included in the container image. The image generator can also inspect the file system access control lists of each of the files in the container image. In some embodiments, the image generator can also assign a security policy to files and directories of the container image based on various security levels. For example, the security levels can include a strict security level that verifies access control lists, checksums, and dates for files accessed by a container image. The security levels can also include a medium security level that includes a checksum and date verification, and a relaxed security level that may not include any verification. In some embodiments, each container image or image type can have a different security level.

In one embodiment, the process flow diagram of FIG. 4 is intended to indicate that the steps of the method 400 are to be executed in a particular order. Alternatively, in other embodiments, the steps of the method 400 can be executed in any suitable order and any suitable number of the steps of the method 400 can be included. Further, any number of additional steps may be included within the method 400, depending on the specific application. For example, the image generator can generate nested container images, wherein each container image can include a globally unique identifier (also referred to herein as a GUID). In some embodiments, each GUID can be used to associate a reparse point with a particular container image. Additionally, the image generator can download container images from a remote source. When the image is downloaded, the image may be directly saved to the container store and used as a container image. Alternatively, a new container image may be created from the downloaded image based on the policy file. To maximize application and hardware compatibility, some embodiments may use a hybrid approach of creating a container image from multiple image sources such as the host image and the downloaded image.

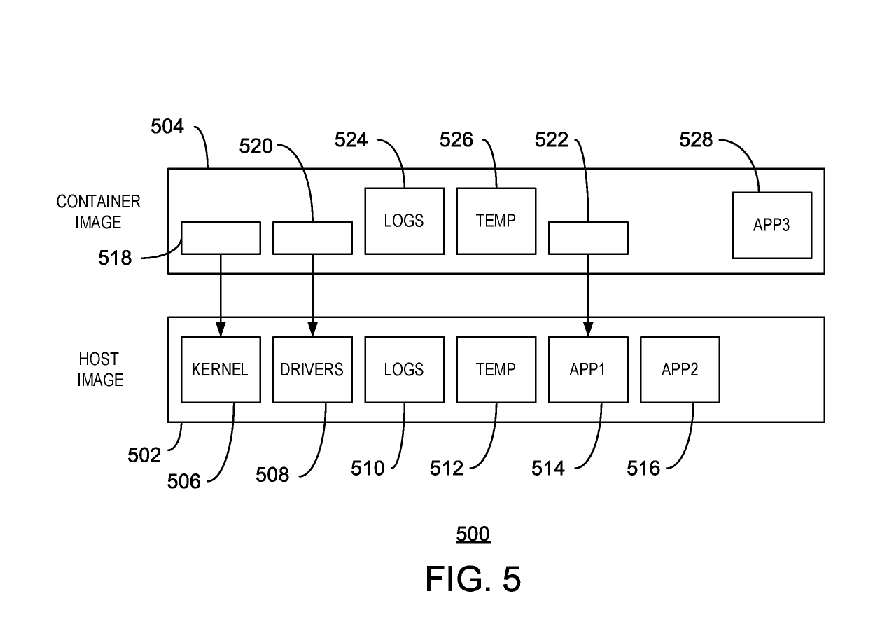

FIG. 5 is a block diagram of an example host image 502 and container image 504. The host image 502 can include any suitable number of kernel files 506, driver 508, log files 510, temporary files 512, an application 1 514, and an application 2 516. In some examples, the host image 502 can include any suitable number of applications. The container image 504 can include reparse points to files in the host image 502 that are not copied to the container image 504. For example, the container image 504 includes a kernel reparse point 518 that is a file system pointer to kernel files 506 in the host image 502. The container image 504 also includes a driver reparse point 520 that is a file system pointer to driver files 508 in the host image 502. The container image 504 can also include an application reparse point 522 that is a file system pointer to application 1 514 in the host image 502. The reparse points enable the container image to be created without storing duplicate files from the host image 502 in the container image 504.

In some embodiments, the container image 504 can also include private or new instances of files or directories stored in the host image 502. For example, a log file directory 524 in the container image and a temporary file directory 526 in the container image 504 can be initialized when generating the container image 504. Initially, the log file directory 524 and the temporary file directory 526 can be empty and may be populated as applications or processes are executed within the container image 504. In some examples, the container image 504 can also include information that is not stored in the host image 502. For example, the container image 504 can include an application 3 528 that is not stored in the host image 502. In some embodiments, the application 3 528 can be loaded from a remote source, an external memory device, and the like. The container image 504 can also include files from the host image 502 that have been modified, new files that have been created, and the like.

It is to be understood that the block diagram of FIG. 5 is not intended to indicate that the host image 502 and the container image 504 are to include all of the components shown in FIG. 5. Rather, the host image 502 and the container image 504 can include fewer or additional components not illustrated in FIG. 5.

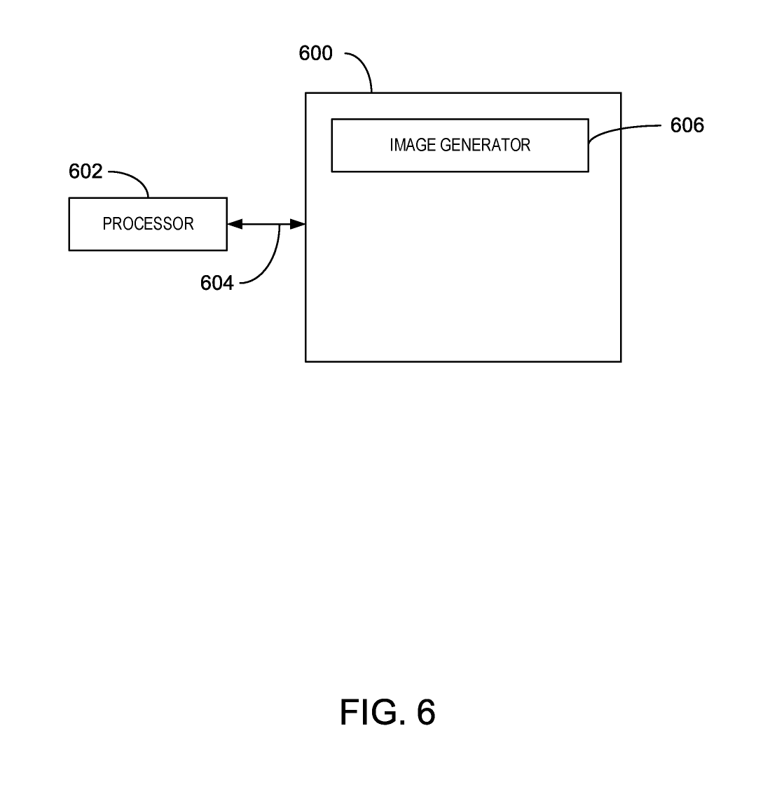

FIG. 6 is a block diagram of an example computer-readable storage media that can dynamically generate a container image. The tangible, computer-readable storage media 600 may be accessed by a processor 602 over a computer bus 604. Furthermore, the tangible, computer-readable storage media 600 may include code to direct the processor 602 to perform the steps of the current method.

The various software components discussed herein may be stored on the tangible, computer-readable storage media 600, as indicated in FIG. 6. For example, the tangible computer-readable storage media 600 can include an image generator 606 that can detect a request to generate a container image based on a policy file and identify a host image from a host operating system. The image generator 606 can also generate the container image based on the host image and the policy file, the policy file indicating a first set of files to be copied from the host image to the container image, a set of reparse points corresponding to a second set of files not to be copied from the host image to the container image, and a third set of files to be loaded into the container image from a remote source.

It is to be understood that any number of additional software components not shown in FIG. 6 may be included within the tangible, computer-readable storage media 600, depending on the specific application.

### Example 1

An embodiment described herein includes a system for generating images comprising a processor that can detect a request to generate a container image based on a policy file and identify a host image from a host operating system. The processor can also generate the container image based on the host image and the policy file, the policy file indicating a first set of files to be copied from the host image to the container image and a set of reparse points to be created in the container image, the set of reparse points corresponding to a second set of files not to be copied from the host image to the container image.

Alternatively, or in addition, the policy file can indicate a new instance of a log file is to be initialized in the container image. Alternatively, or in addition, the policy file can indicate an access control list corresponding to the first set of files, the second set of files, and a third set of files, the third set of files to be loaded into the container image from a remote source. Alternatively, or in addition, the policy file can indicate that the host image is to implement a copy-on-write technique to prevent modifications to the host image from being accessed by the container image. Alternatively, or in addition, the policy file can assign a security level to each of the first set of files. Alternatively, or in addition, the processor can detect a request to modify a file in the host image, generate a copy of the file in the host image, modify a reparse point in the container image to point to the copy of the file, and modify the file. Alternatively, or in addition, the processor can detect a file to be deleted from the host image and maintain a reparse point in the container image corresponding to the file to be deleted. Alternatively, or in addition, the processor can generate a new file in the host image that is inaccessible to the container image. Alternatively, or in addition, the policy file can indicate the container image is to be deleted and a second container image is to be generated in response to detecting a modification to the host image. Alternatively, or in addition, the policy file can indicate the container image is to be deleted and a second container image is to be generated in response to detecting a security vulnerability in the container image. Alternatively, or in addition, the processor can store a downloaded image directly in the container image store and use the downloaded image as the container image. Alternatively, or in addition, the processor can generate the container image from the host image and a downloaded image. Alternatively, or in addition, the processor can generate the container image from a downloaded image based on the policy file.

### Example 2

In another embodiment, a method for generating images can include detecting a request to generate a container image based on a policy file and identifying a host image from a host operating system. The method can also include generating the container image based on the host image and the policy file, the policy file indicating a first set of files to be copied from the host image to the container image, a set of reparse points to be created in the container image, the set of reparse points corresponding to a second set of files not to be copied from the host image to the container image, and a third set of files to be loaded into the container image from a remote source.

Alternatively, or in addition, the policy file can indicate a new instance of a log file is to be initialized in the container image. Alternatively, or in addition, the policy file can indicate an access control list corresponding to the first set of files, the second set of files, and the third set of files. Alternatively, or in addition, the policy file can indicate that the host image is to implement a copy-on-write technique to prevent modifications to the host image from being accessed by the container image. Alternatively, or in addition, the policy file can assign a security level to each of the first set of files. Alternatively, or in addition, the method can include detecting a request to modify a file in the host image, generating a copy of the file in the host image, modifying a reparse point in the container image to point to the copy of the file, and modifying the file. Alternatively, or in addition, the method can include detecting a file to be deleted from the host image and maintaining a reparse point in the container image corresponding to the file to be deleted. Alternatively, or in addition, the method can include generating a new file in the host image that is inaccessible to the container image. Alternatively, or in addition, the policy file can indicate the container image is to be deleted and a second container image is to be generated in response to detecting a modification to the host image. Alternatively, or in addition, the policy file can indicate the container image is to be deleted and a second container image is to be generated in response to detecting a security vulnerability in the container image. Alternatively, or in addition, the method can include storing a downloaded image directly in the container image store and using the downloaded image as the container image. Alternatively, or in addition, the method can include generating the container image from the host image and a downloaded image. Alternatively, or in addition, the method can include generating the container image from a downloaded image based on the policy file.

### Example 3

In yet another embodiment, one or more computer-readable storage devices for dynamically generating images can include a plurality of instructions that, based at least on execution by a processor, cause the processor to detect a request to generate a container image based on a policy file. The plurality of instructions can also cause the processor to identify a host image from a host operating system and generate the container image based on the host image and the policy file, the policy file indicating a first set of files to be copied from the host image to the container image, a set of reparse points to be created in the container image, the set of reparse points corresponding to a second set of files not to be copied from the host image to the container image, and a third set of files to be loaded into the container image from a remote source. Additionally, the plurality of instructions can cause the processor to store the container image in a container image store.

Alternatively, or in addition, the policy file can indicate a new instance of a log file is to be initialized in the container image. Alternatively, or in addition, the policy file can indicate an access control list corresponding to the first set of files, the second set of files, and the third set of files. Alternatively, or in addition, the policy file can indicate that the host image is to implement a copy-on-write technique to prevent modifications to the host image from being accessed by the container image. Alternatively, or in addition, the policy file can assign a security level to each of the first set of files. Alternatively, or in addition, the plurality of instructions can cause the processor to detect a request to modify a file in the host image, generate a copy of the file in the host image, modify a reparse point in the container image to point to the copy of the file, and modify the file. Alternatively, or in addition, the plurality of instructions can cause the processor to detect a file to be deleted from the host image and maintain a reparse point in the container image corresponding to the file to be deleted. Alternatively, or in addition, the plurality of instructions can cause the processor to generate a new file in the host image that is inaccessible to the container image. Alternatively, or in addition, the policy file can indicate the container image is to be deleted and a second container image is to be generated in response to detecting a modification to the host image. Alternatively, or in addition, the policy file can indicate the container image is to be deleted and a second container image is to be generated in response to detecting a security vulnerability in the container image. Alternatively, or in addition, the plurality of instructions can cause the processor to store a downloaded image directly in the container image store and use the downloaded image as the container image. Alternatively, or in addition, the plurality of instructions can cause the processor to generate the container image from the host image and a downloaded image.

Alternatively, or in addition, the plurality of instructions can cause the processor to generate the container image from a downloaded image based on the policy file.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for generating images, comprising:
a processor to:
detect a request to generate a container image based on a policy file;
identify a host image from a host operating system; and
generate the container image based on the host image and the policy file, the policy file indicating a first set of files to be copied from the host image to the container image and a set of reparse points to be created in the container image, the set of reparse points corresponding to a second set of files not to be copied from the host image to the container image.

2. The system of claim 1, wherein the policy file is to indicate a new instance of a log file is to be initialized in the container image.

3. The system of claim 1, wherein the policy file is to indicate an access control list corresponding to the first set of files, the second set of files, and a third set of files, the third set of files to be loaded into the container image from a remote source.

4. The system of claim 1, wherein the policy file is to indicate that the host image is to implement a copy-on-write technique to prevent modifications to the host image from being accessed by the container image.

5. The system of claim 1, wherein the policy file is to assign a security level to each of the first set of files.

6. The system of claim 4, wherein the processor is to:
detect a request to modify a file in the host image;
generate a copy of the file in the host image;
modify a reparse point in the container image to point to the copy of the file; and
modify the file.

7. The system of claim 4, wherein the processor is to:
detect a file to be deleted from the host image; and
maintain a reparse point in the container image corresponding to the file to be deleted.

8. The system of claim 4, wherein the processor is to generate a new file in the host image that is inaccessible to the container image.

9. The system of claim 1, wherein the policy file is to indicate the container image is to be deleted and a second container image is to be generated in response to detecting a modification to the host image.

10. The system of claim 1, wherein the policy file is to indicate the container image is to be deleted and a second container image is to be generated in response to detecting a security vulnerability in the container image.

11. A method for generating images, comprising:
detecting a request to generate a container image based on a policy file;
identifying a host image from a host operating system; and
generating the container image based on the host image and the policy file, the policy file indicating a first set of files to be copied from the host image to the container image, a set of reparse points to be created in the container image, the set of reparse points corresponding to a second set of files not to be copied from the host image to the container image, and a third set of files to be loaded into the container image from a remote source.

12. The method of claim 11, wherein the policy file indicates a new instance of a log file is to be initialized in the container image.

13. The method of claim 11, wherein the policy file indicates an access control list corresponding to the first set of files, the second set of files, and the third set of files.

14. The method of claim 11, wherein the policy file indicates a copy-on-write technique to prevent modifications to the host image from being accessed by the container image.

15. The method of claim 11, wherein the policy file assigns a security level to each of the first set of files.

16. The method of claim 14, comprising:
detecting a request to modify a file in the host image;
generating a copy of the file in the host image;
modifying a reparse point in the container image to point to the copy of the file; and
modifying the file.

17. The method of claim 14, comprising:
detecting a file to be deleted from the host image; and
maintaining a reparse point in the container image corresponding to the file to be deleted.

18. The method of claim 11, comprising generating a new file in the host image that is inaccessible to the container image.

19. The method of claim 11, wherein the policy file indicates the container image is to be deleted and a second container image is to be generated in response to detecting a modification to the host image.

20. One or more computer-readable storage devices for dynamically generating images comprising a plurality of instructions that, based at least on execution by a processor, cause the processor to
detect a request to generate a container image based on a policy file;
identify a host image from a host operating system;
generate the container image based on the host image and the policy file, the policy file indicating a first set of files to be copied from the host image to the container image, a set of reparse points to be created in the container image, the set of reparse points corresponding to a second set of files not to be copied from the host image to the container image, and a third set of files to be loaded into the container image from a remote source; and
store the container image in a container image store.

21. The one or more computer-readable storage devices of claim 20, wherein the plurality of instructions cause the processor to:
store a downloaded image directly in the container image store; and
use the downloaded image as the container image.

22. The one or more computer-readable storage devices of claim 20, wherein the plurality of instructions cause the processor to generate the container image from the host image and a downloaded image.

23. The one or more computer-readable storage devices of claim 20, wherein the plurality of instructions cause the processor to generate the container image from a downloaded image based on the policy file.
